(19) United States
(12) Patent Application Publication
(10) Pub. No.: US 2013/0059214 A1
(43) Pub. Date: Mar. 7, 2013

(54) FUEL CELL CONTAMINANT REMOVAL METHOD

(71) Applicants: Timothy W. Patterson, West Hartford, CT (US); Paravastu Badrinarayanan, Manchester, CT (US)

(72) Inventors: Timothy W. Patterson, West Hartford, CT (US); Paravastu Badrinarayanan, Manchester, CT (US)

(73) Assignee: UTC POWER CORPORATION, South Windsor, CT (US)

(21) Appl. No.: 13/697,879

(22) PCT Filed: May 27, 2010
(86) PCT No.: PCT/US10/36276

§ 371 Date: Nov. 14, 2012

(51) Int. Cl. H01M 8/06

(52) U.S. Cl. 429/410

(57) ABSTRACT

An example method of operating a fuel cell system includes calculating the rate of water produced in the fuel cell stack, determining the rate of water exiting the system, and controlling the condenser temperature to maintain the cathode gas exit temperature from the condenser below the temperature required to maintain water balance in the fuel cell system. The method collects the condensed vapor as water and purges a portion of the collected water containing contaminants from the system.

### CROSS-REFERENCE TO RELATED APPLICATIONS

This application is the U.S. national phase of PCT/US2010/036276, filed May 27, 2010.

### TECHNICAL FIELD

This disclosure relates generally to a fuel cell system. In particular, this disclosure relates to removing contaminants from the fuel cell system.

### DESCRIPTION OF RELATED ART

Fuel cell assemblies are well known. One example fuel cell system includes multiple individual fuel cells arranged in a stack. Each individual fuel cell has an anode and a cathode positioned on either side of proton exchange membrane. A fuel, such as hydrogen, is supplied to the anode side of the proton exchange membrane. An oxidant, such as air, is supplied to the cathode side of the proton exchange membrane. Gas diffusion layers help distribute the fuel and the oxidant to the proton exchange membrane. As known, the chemical reactions within the fuel cell produce water that exits the fuel cell in liquid and vapor form.

Some fuel cell assemblies communicate water produced by a fuel cell to a heat exchanger or condenser. The water carries thermal energy away from the fuel cell, which cools the fuel cell. The cooled water is then returned to the fuel cell to absorb more thermal energy. The water can contain ionic and other contaminants that can poison the individual fuel cells and degrade fuel cell performance. Many fuel cell assemblies communicate the water through a demineralizer bed to remove contaminants from the water before returning the water to the fuel cell. Demineralizer resin within the demineralizer bed must be periodically replaced. The demineralizer bed adds cost and complexity to fuel cell assemblies.

### SUMMARY

An example method of operating a fuel cell system includes calculating the rate of water produced in the fuel cell stack, determining the rate of water exiting the system, and controlling the condenser temperature to maintain the cathode gas exit temperature from the condenser below the temperature required to maintain water balance in the fuel cell system. The method collects the condensed vapor as water and purges a portion of the collected water containing contaminants from the system.

An example method of removing contaminants from a fuel cell system includes condensing water vapor from the cathode exit stream and collecting the condensed vapor as water. The method also collects liquid water produced in the stack and holds the collected water in the system. The method purges a portion of the collected water containing contaminants from the system.

Yet another example method of removing contaminants from a fuel cell system includes controlling the system such that the fuel cell stack rate of water production is greater than the amount of water exiting the fuel cell system. The method drains a portion of the system water containing contaminants from the system.

These and other features of the example disclosure can be best understood from the following specification and drawings, the following of which is a brief description:

### BRIEF DESCRIPTION OF THE DRAWINGS

FIG. 1 shows schematic view of an example fuel cell system incorporating a condenser to remove thermal energy from water vapor provided by a fuel cell of the fuel cell system.

FIG. 2 shows a schematic view of another example fuel cell system incorporating an intermediate heat exchanger to remove thermal energy from liquid water provided by a fuel cell of the fuel cell system.

FIG. 3 shows a schematic view of another example fuel cell system incorporating a condenser to remove thermal energy from water vapor provided by a fuel cell of the fuel cell system.

FIG. 4 shows a schematic view of another example fuel cell system incorporating a condenser to remove thermal energy from water vapor provided by a fuel cell of the fuel cell system.

### DETAILED DESCRIPTION

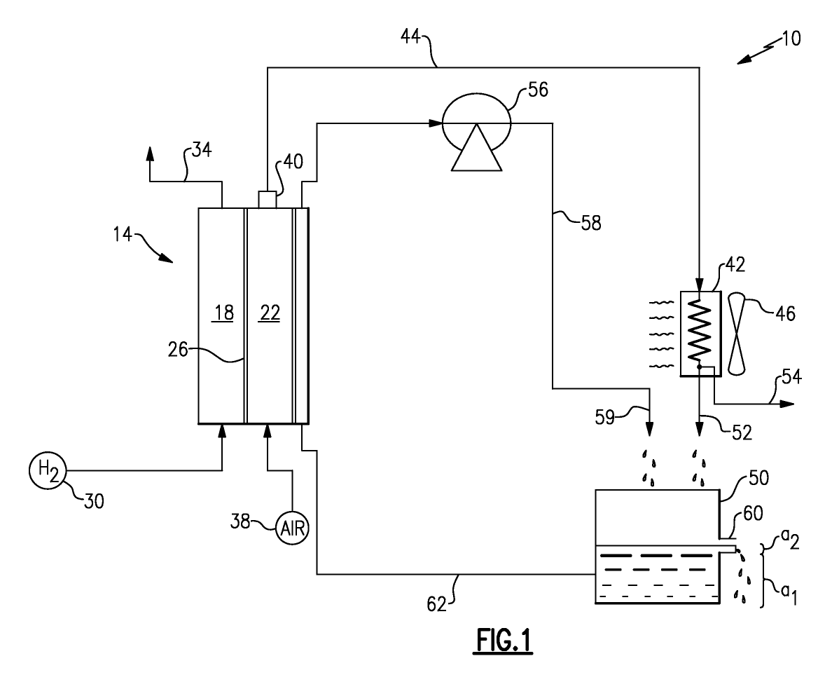

Referring to FIG. 1, an example fuel cell system 10 includes a fuel cell 14 having an anode 18 and a cathode 22 separated by a proton exchange membrane 26. A fuel source 30 supplies a fuel, such as hydrogen, to the anode 18 of the fuel cell 14. Some of the fuel is exhausted from the fuel cell 14 at a fuel exhaust 34. An oxidant source 38 supplies an oxidant, such as air, to the cathode 22 of the fuel cell 14. Some of the air is exhausted from the fuel cell 14 at an air exhaust 40. The exhausted air carries water vapor from the fuel cell 14 as is known. Chemical reactions within the fuel cell 14 produce the water vapor carried by the exhausted air.

Hydrogen-air PEM fuel cell systems, such as the system 10 shown in FIG. 1, produce water as a byproduct. If the total amount of water vapor exhausting from the system 10 equals the water that is produced by the fuel cell 14, the system 10 can be said to be operating in water balance.

If the operating conditions are such that the water vapor leaving the system 10 is higher than the water produced by the fuel cell 14, the system 10 can be said to be in negative water balance. In some examples, an external source of water is needed to replenish lost water if the system 10 is operating in negative water balance.

If operating conditions are chosen such that water vapor leaving the system 10 is less than the water produced, the system 10 can be said to be operating in positive water balance. In some examples, there is a build-up of liquid water in the system 10 requiring removal of the excess water in some form if the system 10 is operating in positive water balance.

In this example, the exhausted air carrying water vapor is communicated to a condenser heat exchanger 42 along a path 44. A fan 46 moves air across the condenser heat exchanger 42 to cool the exhausted air and condense the water vapor carried by the exhausted air. The condensate is separated from the exhausted air and communicated to an accumulator tank 50 at an outlet 52. The remaining portions of the exhausted air are vented to the surrounding environment at an outlet 54.

Chemical reactions within the fuel cell 14 produce liquid water in addition to the water vapor carried by the exhausted air. In this example, a pump 56 is used to communicate the liquid water from the fuel cell 14 to the accumulator tank 50 along a path 58 to an outlet 59 or another conduit. The liquid water moves through the pump 56 in this example.

The liquid water pumped from the fuel cell 14 combines with the condensate in the accumulator tank 50. Both the liquid water pumped from the fuel cell 14 and the condensate communicated from the condensing heat exchanger 42 carry contaminants, such as ionic contaminants.

The water level within the accumulator tank 50 rises as more water is added to the accumulator tank 50. If the water level exceeds a certain level, the excess water drains from the accumulator tank 50 through an overflow valve 60 to the ground, for example.

In this example, the accumulator tank 50 holds a first amount of water a₁, and a second amount of water a₂ (if introduced to the accumulator tank 50) spills through the overflow valve 60 or another type of conduit.

The first amount of water a₁ (i.e., the water held by the accumulator tank 50 below the overflow valve 60) is configured to move back to the fuel cell 14 along the path 62. This water moves through the fuel cell 14 and absorbs thermal energy. Circulating liquid water from through the fuel cell 14 cools the fuel cell 14.

The second amount of water a₂ (i.e., the water discharged through the overflow valve) does not flow back to the fuel cell 14. The second amount of water a₂ carries some contaminants away from the fuel cell system 10.

In this example, the fan 46 moves air across the condensing heat exchanger 42. The moving air cools the water vapor and condenses liquid water from the water vapor. Increasing the speed of the fan 46 will more effectively cool the water vapor as more air is moving across the condensing heat exchanger 42. Increased cooling of the water vapor increases the condensate removed from the water vapor.

In some examples, a user increases the speed of the fan 46 to move more condensate into the accumulator tank 50 and thus increase liquid water within the fuel cell system 10.

As can be appreciated, increasing the amount of condensate in the accumulator tank 50 increases the second amount of water and thus the amount of water (and associated contaminants) exiting the fuel cell system 10 through the overflow valve 60.

Although the fuel cell system 10 is shown as having one fuel cell 14, those skilled in the art and having the benefit of this disclosure will understand that other fuel cell assemblies may include several individual, water-cooled, individual fuel cells arranged in a fuel cell stack or still other fuel cell configurations.

In this disclosure, like reference numerals designate like elements where appropriate, and reference numerals with the addition of one-hundred or multiples thereof designate modified elements. The modified elements incorporate the same features and benefits of the corresponding modified elements, expect where stated otherwise.

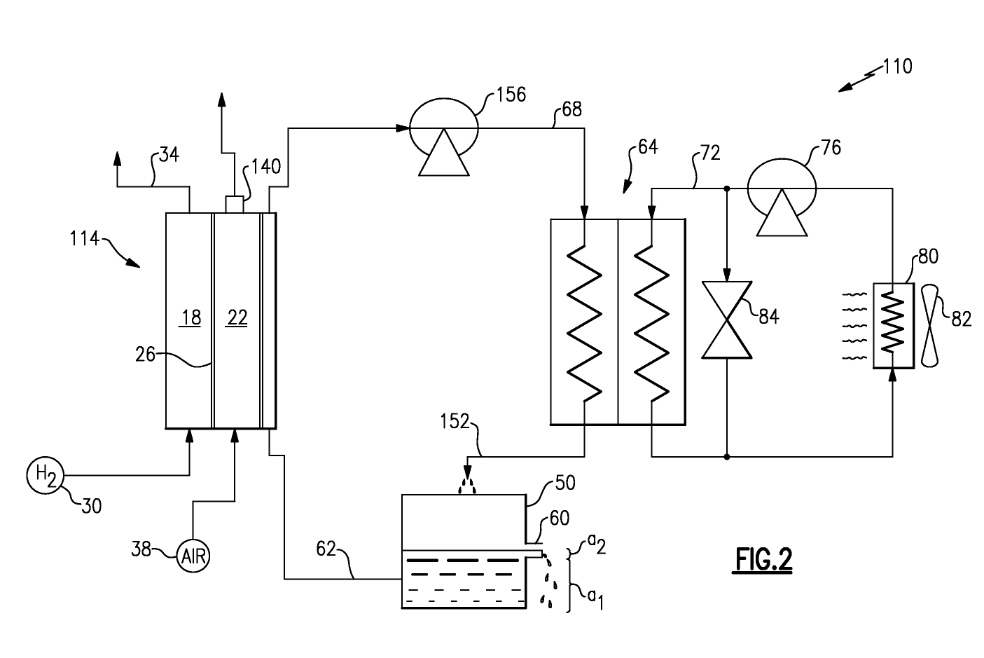

Referring to FIG. 2, another example fuel cell system 110 includes a fuel cell 114 that exhausts air directly to the surrounding environment at an air exhaust 140. The exhausted air carries water vapor from the fuel cell 14 as is known.

A pump 156 moves liquid water from the fuel cell 114 to an intermediate heat exchanger 64 along a path 68. After moving through the intermediate heat exchanger 64, the liquid water is communicated to the accumulator tank 50 through an outlet 152. The water level within the accumulator tank 50 rises as more water is added to the accumulator tank 50. If the water level exceeds a certain level, the excess water drains from the accumulator tank 50 through the overflow valve 60 to the ground, for example.

The liquid water carries thermal energy away from the fuel cell 114 to cool the fuel cell 114. Within the intermediate heat exchanger 64, the thermal energy moves from the water to another fluid circulating along a path 72. The other fluid is a glycol solution in this example.

A pump 76 moves the glycol solution along the path 72 between the intermediate heat exchanger 64 and an air-cooled radiator 80. A fan 82 moves air across the radiator 80. The moving air carries some of the thermal energy away from the glycol solution.

In this example, a bypass valve 84 is used to control the operating temperature of the fuel cell 114 and thus the water balance of the fuel cell system 110. More specifically, reducing flow through the bypass valve 84 increases flow of glycol solution through the intermediate heat exchanger 64.

As can be appreciated, more thermal energy is removed from the liquid water when more glycol solution moves through the intermediate heat exchanger 64. Removing more thermal energy from the liquid water lowers the operating temperature of the fuel cell 114. Operating the fuel cell 114 at the lower operating temperature decreases the amount of water exiting the fuel cell 114 as water vapor at an air exhaust 140. Operating the fuel cell 114 at the lower operating temperature also increases the amount of water exiting the fuel cell 114 as liquid water at the path 68.

The liquid water exiting the fuel cell 114 contains contaminants. Removing some of the liquid water from the fuel cell system 110 through the overflow valve 60 removes contaminants from the fuel cell system 110. Operating the fuel cell 114 at a water surplus facilitates removing liquid water from the fuel cell 114.

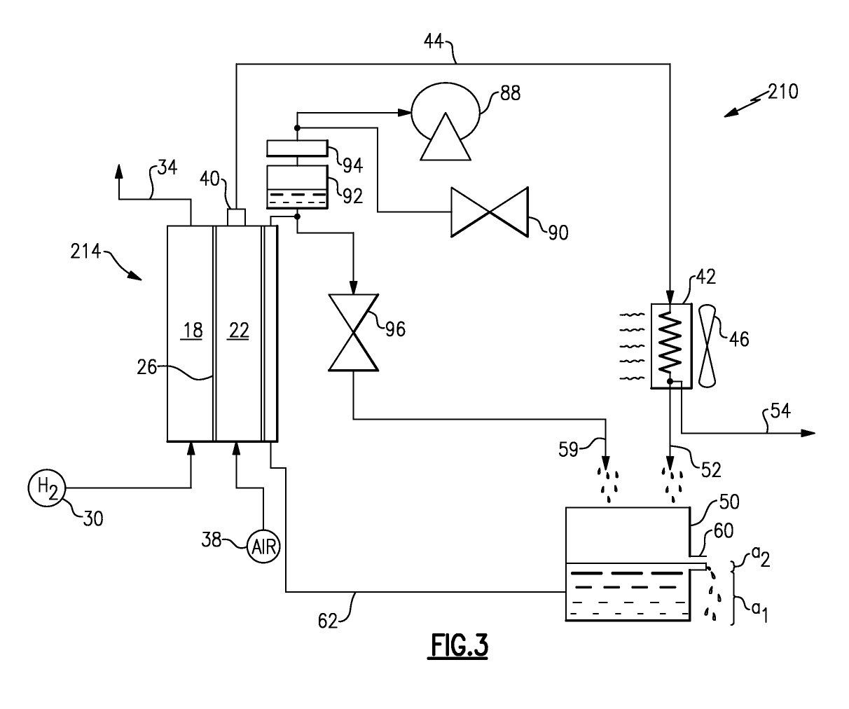

Referring now to FIG. 3, another example fuel cell system 210 includes a vacuum pump 88 and a vacuum break 90. The vacuum pump 88 draws a vacuum to communicate liquid water away from a fuel cell 214 to a second accumulator tank 92. When the liquid water reaches an established level within the second accumulator tank 92, a level switch 94 actuates and opens the vacuum break 90. The vacuum break 90, when open, enables liquid water to flow or slump from the second accumulator tank 92 through a coolant return valve 96 to the accumulator tank 50. The vacuum break 90 opens and closes intermittently, say every 1-2 seconds, which causes liquid water to pulse through the fuel cell 214.

In this example, the coolant return valve 96 contacts water, which can potentially freeze during cold shutdowns. The coolant return valve 96 is thus typically moved to a closed position during shutdown. A heater (not shown) is used in one example to thaw the coolant return valve 96 after start up of the fuel cell system 210.

As with the example of FIG. 1, an operator may increases the speed of the fan 46 to increase liquid water within the fuel cell system 210 by moving more condensate into the accumulator tank 50.

Again, increasing the amount of condensate in the accumulator tank 50 increases the second amount of water and thus the amount of water (and associated contaminants) exiting the fuel cell system 10 through the overflow valve 60.

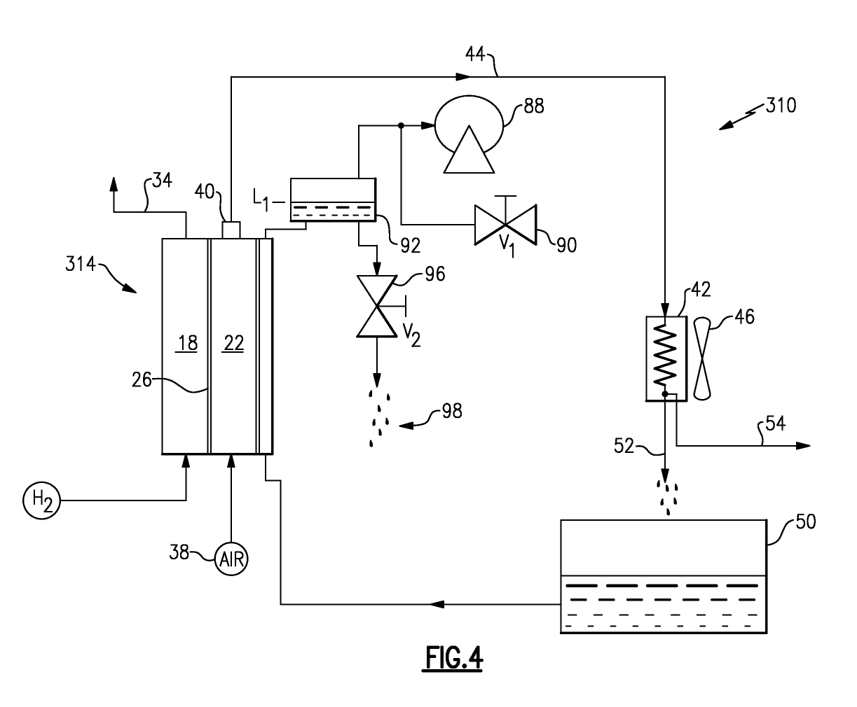

Referring to FIG. 4, another example fuel cell system 310 is evaporatively cooled. The system 310 includes the vacuum pump 88 and the vacuum break 90. The vacuum pump 88 draws a vacuum to communicate liquid water away from a fuel cell 314 to the second accumulator tank 92. The vacuum break 90 opens and closes periodically to maintain a level of the liquid in the tank 92 at a level L₁. The coolant return valve 96 opens periodically with the vacuum break 90 to allow the water (and associated contaminants) to pass through the valve 96 to be expelled from the system 310.

Features of the disclosed examples include controlling a fuel cell system to operate at a water surplus and then removing the surplus water (and associated contaminants) from the fuel cell system. Another feature of the disclosed examples includes removing contaminants from a fuel cell system without using a demineralizer bed. Automotive, bus, and stationary fuel cell powerplants could incorporate these features.

Other features of the disclosed examples include operating a fuel cell system in positive water balance by selecting relevant heat exchanger and fuel cell operating parameters. As this extra liquid water in the system contains the contaminants in the same concentration as the general water in the coolant system, exhausting some of the liquid water will get rid of some of the contaminants. The extent to which the system is operated in positive water balance (i.e., the rate of water production minus the rate of water vapor removed through exhaust) can be adjusted based on the amount of contamination that is expected to leach out into the coolant system.

Although a preferred embodiment has been disclosed, a worker of ordinary skill in this art would recognize that certain modifications would come within the scope of this invention. For that reason, the following claims should be studied to determine the true scope and content of this invention.

We claim:

1. A method of removing contaminants from a fuel cell system, comprising:
a) controlling the system such that the fuel cell stack rate of water production is greater than the amount of water exiting the fuel cell system; and
b) draining a portion of the system water containing contaminants from the system

2. The method of claim 1, wherein the draining of water from the fuel cell system is performed periodically.

3. The method of claim 1, wherein the contaminants comprise ionic contaminants.

4. The method of claim 1, wherein the fuel cell system does not include a demineralizer bed.

5. The method of claim 1, including draining the portion of the system water after communicating through a heat exchanger.

6. The method of claim 1, wherein the controlling includes operating the fuel cell system at a lower operating temperature.

7. The method of claim 6, including cooling the fuel cell stack by increasing flow of a coolant through a heat exchanger, the coolant configured to thermally communicate with the portion of the system water.

8. The method of claim 1, wherein the draining comprises draining the portion of the system water from an accumulator tank.

9. The method of claim 8, wherein the portion of the system water comprises condensate communicated from a condenser of the fuel cell system.

10. The method of claim 8, wherein the draining comprises removing overflow from the water accumulator tank.

11. A method of removing contaminants from a fuel cell system, comprising:
a) condensing water vapor from the cathode exit stream;
b) collecting the condensed vapor as water;
c) collecting liquid water produced in the stack;
d) holding the collected water in the system; and
e) purging a portion of the collected water containing contaminants from the system.

12. The method of claim 11, wherein the purged portion of water maintains the system in overall water balance.

13. The method of claim 11, including operating a fuel cell of the system at a cooler temperature to increase the collected water.

14. The method of claim 11, including circulating some of the water through a fuel cell of the fuel cell system to remove thermal energy from the fuel cell.

15. The method of claim 11, wherein the purging comprises periodically exhausting a predetermined quantity of liquid water and contaminants from the fuel cell system.

16. A method of operating a fuel cell system comprising:
a) calculating the rate of water produced in the fuel cell stack;
b) determine the rate of water exiting the system;
c) controlling the condenser temperature to maintain the cathode gas exit temperature from the condenser below the temperature required to maintain water balance in the fuel cell system;
c) collecting the condensed vapor as water; and
d) purging a portion of the collected water containing contaminants from the system.

17. The method of claim 16, wherein the purging of water from the fuel cell system is performed periodically.
